(19) United States
(12) Patent Application Publication
(10) Pub. No.: US 2021/0107515 A1
(43) Pub. Date: Apr. 15, 2021

(54) SYSTEMS AND METHODS FOR VISUALIZING A ROUTE OF A VEHICLE

(71) Applicant: Ford Global Technologies, LLC, Dearborn, MI (US)

(72) Inventors: Elena Lazaridis, Rosrath (DE); Florian Vieten, Nordhein-Westfalen (DE); Gerrit Wigger, Koeln (DE); Florian Krins, Hurth (DE)

(21) Appl. No.: 17/065,092

(22) Filed: Oct. 7, 2020

(30) Foreign Application Priority Data
Oct. 10, 2019 (DE) 102019215524.3

(51) Int. Cl. B60W 60/00; B60W 30/06; G05D 1/00; G06K 9/00

(52) U.S. Cl. CPC B60W 60/0011; B60W 30/06; B60W 2554/20; G06K 9/00791; B60W 2420/42; G05D 1/0038

(57) ABSTRACT

A method for visualizing a route R to be followed by a vehicle F is disclosed. The method comprises: providing information about the position and orientation of the vehicle F with respect to its vehicle surroundings and with respect to a mobile terminal M (I), providing information about the profile of the route R to be followed (II), capturing vehicle surroundings of the vehicle F by means of a camera device of the mobile terminal M (III), determining the profile of the route R to be followed in the captured vehicle surroundings on the basis of the information provided (IV), displaying an image A of the captured vehicle surroundings on a display D of the mobile terminal M (V) and representing the profile of the route R to be followed in the image A of the captured vehicle surroundings (VI).

### CROSS-REFERENCE TO RELATED APPLICATIONS

The disclosure claims priority to and the benefit of DE Patent Application No. 102019215524.3, filed Oct. 10, 2019, which is hereby incorporated by reference herein in its entirety.

### FIELD

The disclosure relates to systems and methods for visualizing a route to be followed by a vehicle, which may be executable on or by a computer (e.g., processes and memory), a computer program product, and/or a computer-readable storage medium.

### BACKGROUND

Parking assistance systems which assist a parking process, or even carry it out independently, are known. For example, DE 10 2016 205 285 A1 discloses a control device for remote-controlling a motor vehicle, which device has a display apparatus for visualizing surroundings of the vehicle which are captured by sensors of the motor vehicle and a vehicle symbol which represents the motor vehicle. By means of an input device, a desired parked position within the captured vehicle surroundings can be input by moving the vehicle symbol. The surroundings of the vehicle are, however, represented merely symbolically, which makes a comparison with reality difficult.

DE 10 2018 206 603 A1 describes a method in which a parking area is captured on the basis of road signs, markings, etc. A maneuver for parking on the captured parking area is carried out in an automated fashion by means of an image which is generated of the surroundings of the vehicle.

An interface for executing a remote-controlled parking maneuver is known from DE 10 2018 114 199 A1.

WO 2017/137 046 A1 discloses a parking assistance system which captures lines, pictograms etc. on an area on which a vehicle is to be parked and displays them in the vehicle. After the vehicle has been parked on this area, the driver can therefore check whether there is possibly an indication of a parking restriction or the like located under his vehicle.

DE 10 2018 220 279 A1 describes an imaging system for displaying a target position of a vehicle and a target position indicator. Furthermore, a target route indicator is provided which comprises waylines which represent the target route of the vehicle.

A further parking assistance system is known from WO 2018/017 094 A1. A control unit for an autonomous vehicle generates a reference image according to sensor outputs which show the surroundings of the vehicle. The reference image is transmitted to the mobile device of a driver. While the driver is located outside the vehicle, the driver indicates on the mobile device a trajectory to be followed by the vehicle for autonomous parking. The control unit receives the trajectory, validates it and executes it, while adaptations in reaction to detected obstacles or other conditions are implemented. The reference image and the trajectory can be stored and subsequently used for autonomous parking of the vehicle. The control unit can receive an external image from the mobile device, merge it with data from the sensor outputs and transmit this as a reference image to the mobile device.

When a parking assistance system is used, the driver may be located next to the vehicle and initiate a parking maneuver from outside by means of remote control. For example, the vehicle can implement a previously learnt route which is stored as a trajectory, from a defined starting position to a defined parking position. Since the driver is not located in the vehicle and in addition does not even have to monitor the parking maneuver, the driver may not know the profile of the route (any longer) or cannot imagine the actual profile of the route in the terrain or can only do so to a limited degree. This can lead to a situation in which obstacles, e.g. garbage cans, garden implements etc. which possible impede the parking maneuver are placed on the route, or obstacles which are present are not detected as such by the driver. Furthermore, the selection of a specific route can be made difficult if a plurality of possible routes which start at the same starting position are stored.

Against this background, the object of the invention is to disclose possibilities with which the inadequacies described above can be at least alleviated.

### SUMMARY

This object is achieved by means of the subject matters of the independent claims. Advantageous developments of the invention are disclosed in the dependent claims.

The basic concept of the invention is to provide a user, e.g. a driver of a vehicle, with the possibility of representing a recorded driving path using augmented reality on the display of a mobile terminal, e.g. smartphone, tablet, smartwatch etc. The position and orientation of the mobile terminal relative to the vehicle are known. The mobile terminal uses its own camera to depict the surroundings and represents the image on the display. This image of the actual surroundings is augmented with virtual elements (a planned route, highlighting of objects in the route, etc.).

The user can move the mobile terminal in space. If the camera of the mobile terminal captures, for example, a part of the route to be followed or the trajectory to be adopted, this is highlighted image represented in the display. The driver therefore has, for example, the possibility of travelling along the entire route and of having displayed to him and checking whether the route of the vehicle is free of obstacles.

A first aspect of the invention relates to a method for visualizing a route to be followed by a vehicle. The method can be executed partially or preferably completely in a computer-implemented fashion.

Firstly, information about the position and orientation of the vehicle with respect to its vehicle surroundings and with respect to a mobile terminal is provided. In other words, for the method to be carried out the position and orientation of the vehicle with respect to the surroundings of the vehicle and with respect to the mobile terminal must be known. This can be achieved by means of corresponding processing of positioning data, e.g. GPS (global positioning system) data, if appropriate taking into account a route previously followed by the vehicle, e.g. by relocalization using information from the surroundings sensor system.

A vehicle can be understood to be any mobile means of transportation, i.e. both a land vehicle and a watercraft or aircraft, e.g. a passenger car. The vehicle can be embodied as a partially autonomous or autonomous vehicle. An autonomous vehicle can be understood to be a self-propelled vehicle which can execute all the safety-critical functions for the entire driving process, so that there is no need for control by the vehicle driver or driver at any time. The vehicle controls all the functions from the start to the stop, including all the parking functions. In addition, a manual mode can also be provided in which a human vehicle driver controls all or some of the vehicle functions. If the vehicle driver controls some of the vehicle functions himself, the vehicle is a partially autonomous vehicle. The term “vehicle surroundings” means the surroundings of this vehicle.

A mobile terminal can be understood to be a portable communication device which can be used in a transportable fashion for voice and data communication, e.g. a cellphone, smartphone, smartwatch, netbook, notebook, tablet, etc. The mobile terminal has a processing unit for data processing and a display for representing display contents. Furthermore, there can be a transmission device for receiving and optionally also transmitting data. The transmission device can preferably be designed to carry out wireless transmission, e.g. by means of radio signals. The transmission device can be embodied as a WLAN (wireless local area network) module, Bluetooth® module, mobile radio module, etc.

In addition, there can be an input device with which commands can be issued to the mobile terminal and/or elements can be selected. The mobile terminal is preferably arranged outside the vehicle. The mobile terminal can be controlled by a user, e.g. the driver of the vehicle or else some other person.

In addition to information about the position and orientation of the vehicle, information about the profile of the route to be followed, that is to say the planned route, are provided e.g. in the form of a trajectory.

For example, the route to be followed can be a previously recorded trajectory which has been recorded e.g. by travelling along it once and can subsequently be implemented by the vehicle on its own, insofar as the vehicle is in a corresponding starting position. Alternatively, the route can be one which is defined in some other way, e.g. a route which has the purpose of reaching a predefinable destination and is determined and defined by an autonomous or partially autonomous vehicle.

The information about the profile of the route to be followed can be stored, for example in the mobile terminal or can be determined by said terminal itself. The same applies to the information about the position and orientation of the vehicle. Alternatively, the information can be stored or generated externally, e.g. in the vehicle, and transmitted for further processing, e.g. for the execution of the further method steps, to the mobile terminal

However, in addition, there is also the possibility that further method steps are not executed by the mobile terminal itself but rather externally, e.g. by a processing unit of the vehicle or in an Internet-based fashion and the result of this further processing is transmitted to the mobile terminal. Consequently, the information about the position and orientation of the vehicle as well as about the profile of the route to be followed can also be provided to an external processing unit.

In a further method step, the vehicle surroundings of the vehicle are captured by means of a camera device of the mobile terminal. The profile of the route to be followed is then determined in the captured vehicle surroundings on the basis of the information provided. Finally, an image of the captured vehicle surroundings is displayed on a display of the mobile display device, wherein the profile of the route to be followed is represented in the image of the captured vehicle surroundings.

In other words, the computer-generated profile of the route is added to the displayed image of the surroundings of the vehicle by including the profile of the route as a virtual element in the image or superimposing the image and profile of the route. The surroundings of the vehicle and the profile of the route have a three-dimensional relationship with one another here.

If the surroundings of the vehicle are captured only in a region in which the route to be followed is not located, a message, e.g. in the form of an auxiliary representation (direction arrow, etc.), audio output etc. can be optionally output. The message can comprise a recommendation for action for changing the position of the camera device, in order to capture that region of the surroundings of the vehicle in which the route to be followed is located.

The generated image with the represented profile of the route to be followed can then be used by the user to be able to estimate the profile of the route under conditions close to reality. It is therefore possible to detect obstacles in the region of the route to be followed and to prevent a collision of the vehicle with said obstacles, for example.

According to various embodiment variants, the vehicle surroundings can be captured dynamically and a dynamic image can be displayed.

This means that not only is a photographic recording of the surroundings of the vehicle made but the surroundings of the vehicle are, for example, filmed and a moving image is displayed. When the mobile terminal moves, that is to say when there is a change in position of the camera device of the mobile terminal, the display content of the display consequently changes. By scanning the surroundings of the vehicle it is advantageously possible to obtain a particularly good overview over the profile of the route.

According to further embodiment variants, the image can be a photographic image.

This means that the actual surroundings of the vehicle are displayed and not only a simplified graphic. This advantageously makes orientation for the user easier since the user can compare better the profile of the route to be followed with the surroundings of the vehicle.

According to further embodiment variants, the method can comprise highlighting objects and/or waypoints in the image and/or highlighting a target position of the route to be followed in the image.

For example, objects, such as for example garbage cans, gardening implements and toys which are located in an area of the route to be followed, that is to say which would impede the travel along the route by the vehicle, can be highlighted in the image. Waypoints may be e.g. hazardous points, planned stopping points, changes of direction, etc. The highlighting can be done e.g. by means of color marking, a change in color or a flashing representation. Furthermore, further objects such as e.g. a garage door can also be highlighted.

Alternatively or additionally, the target position of the route to be followed, that is to say its end, can be highlighted.

The highlighting of objects and/or waypoints and/or of the target position can permit the orientation of the user when viewing the image to be improved. Any obstacles can be recognized better and suitable measures taken early.

There is optionally the possibility, in certain cases, e.g. when objects are present in the area of the route to be followed, of outputting an acoustic and/or haptic warning message. As a result, the user can be alerted better to this fact.

According to further embodiment variants, the method can comprise representing alternative routes in the image of the captured vehicle surroundings.

In this case information about the profile of these alternatives routes must be provided. The alternative routes can be differentiated from one another by means of different coloring or other markings which differ from one another.

The user can advantageously appraise profiles of a plurality of routes.

The method can optionally comprise transmitting a selection of one of the alternative routes to the vehicle. In other words, there can be the possibility of the user selecting one of the alternative routes, e.g. by means of a touch command on the display which simultaneously serves as an input device. The selection can be transmitted to the vehicle and used as a basis for the further driving process so that the vehicle can e.g. autonomously implement the selected route.

According to further embodiment variants, the route to be followed can be the route of a parking process.

Parking processes are increasingly carried out partially autonomously or autonomously. Visualization of the corresponding route according to the described method steps contribute to increasing safety since the route to be followed can be monitored better.

A further aspect of the invention relates to an arrangement for visualizing a route to be followed by a vehicle. The arrangement comprises means which are suitable for executing the steps of a method according to the description above.

Consequently the advantages of the explained methods are correspondingly connected to the arrangement according to the invention. All the statements relating to the method according to the invention can be correspondingly transferred to the arrangement according to the invention.

The means can comprise a mobile terminal with a camera device for capturing the surroundings of the vehicle and with a display for displaying the image of the captured surroundings of the vehicle with a represented profile of the route to be followed.

The means can furthermore comprise a processing device for data processing, a transmission device for receiving and optionally also transmitting data as well as an input device. Furthermore, a storage unit for storing data can be provided. The specified units and devices can be part of the mobile terminal. In other words, the arrangement can be a mobile terminal.

A further aspect of the invention relates to a computer program product which comprises commands which cause the arrangement described above to execute the steps of one of the methods described above.

A computer program product can be understood to be a program code which is stored on a suitable medium and/or can be retrieved via a suitable medium. Any medium which is suitable for storing software, for example a non-volatile memory which is installed in a control device, a DVD, a USB stick, a Flash card or the like can be used to store the program code. The retrieval of the program code can be carried out, for example, via the Internet or an Intranet or via some other suitable wireless or cable-bound network.

A further aspect of the invention relates to a computer-readable storage medium on which the computer program product is stored.

The advantages of the method according to the invention are correspondingly linked to the computer program product according to the invention and the computer-readable storage medium according to the invention.

### BRIEF DESCRIPTION OF THE DRAWINGS

The invention will be explained below with reference to the figures and the following description.

FIG. 1 shows a flow diagram of an exemplary method;

FIG. 2 shows a further flow diagram of an exemplary method;

FIG. 3 shows an overview of an exemplary scenario;

FIG. 4 shows an exemplary image of captured surroundings of a vehicle from the position X1 of the exemplary scenario shown in FIG. 3;

FIG. 5 shows an exemplary image of captured surroundings of a vehicle from the position X2 of the exemplary scenario shown in FIG. 3;

FIG. 6 shows a further exemplary image with a represented profile of the route to be followed;

FIG. 7 shows a further exemplary image with a represented profile of the route to be followed and highlighted object and highlighted target position; and

FIG. 8 shows a further exemplary image with represented alternative routes.

### DETAILED DESCRIPTION

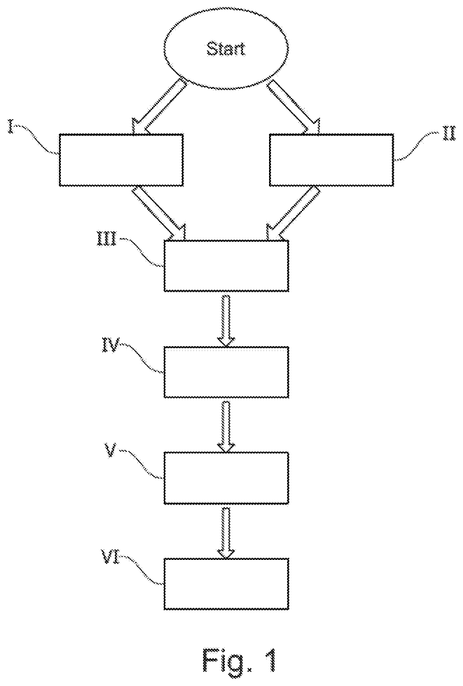

FIG. 1 shows a flow diagram of an exemplary method having the steps Ito VI. After the start of the method, in step I information about the position and orientation of the vehicle F with respect to its vehicle surroundings and with respect to a mobile terminal M are provided. The information about the position and orientation of the vehicle F with respect to the mobile terminal M can comprise the distance between the vehicle F and the mobile terminal M, the inclination angle of the mobile terminal M and its orientation. The information serves as a basis for the determination of the profile of the route R to be followed and its correct representation in the displayed image A of the captured surroundings of the vehicle.

In the exemplary embodiment, the vehicle is a passenger car and the mobile terminal is a smartphone, but the invention is not limited to these. The mobile terminal has a display D, a camera device, a processing unit, a transmission unit and an input device in the form of a touch screen.

Furthermore, in step II information about the profile of the route R to be followed is provided. The route R can be e.g. the route of a parking process, for example the route from entry into a property up to in front of a garage or into a garage. The profile of the route R may have been recorded once in advance and have been stored in the mobile terminal or externally.

The steps I and II can be executed chronologically in parallel or in any desired chronological sequence.

In step III, the vehicle surroundings of the vehicle F are captured, e.g. filmed, by means of a camera device of the mobile terminal M. In step IV, the profile of the route R to be followed in the captured vehicle surroundings is determined on the basis of the information provided.

In step V, an image A of the captured vehicle surroundings is displayed on the display D of the mobile terminal M, wherein in step VI the profile of the route R to be followed is represented in the image A of the captured vehicle surroundings VI.

The method permits a user to use augmented reality methods to have the route R of the vehicle F which is planned or to be followed displayed to him on the display D of his smartphone. The camera device of the smartphone is used to film the surroundings and represent them on the display D of the smartphone. Virtual elements for representing the route R to be followed are included in this image A of the actual surroundings. Objects O and/or hazardous points, planned stopping points, changes of direction etc. can optionally be highlighted in the region of the route R.

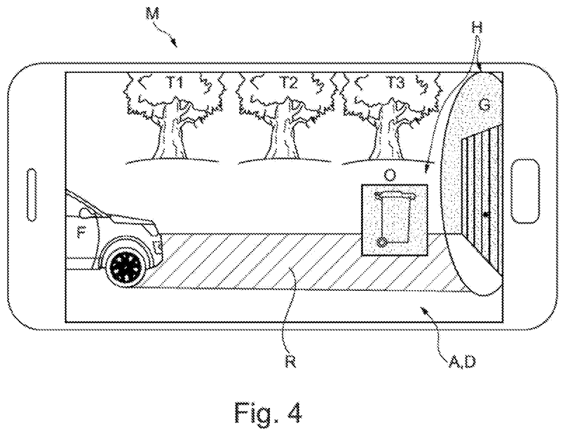

The user can move the smartphone in space so that the surroundings of the vehicle are captured dynamically and a dynamic image A is displayed. If the camera device of the smartphone captures, for example, part of the route to be followed, this is highlighted in the image A (FIGS. 4 to 8). As a result, the user has the possibility of moving along the entire route and having it displayed to him and checking whether the route R of the vehicle F is free of obstacles. This can occur, for example, when the user has just got out of the vehicle F and is still standing next to the vehicle F.

If the user orients the smartphone in such a way that the camera device of the smartphone does not capture the route R (not even partially), assistance can be displayed to him on the image A, for example a directional arrow which indicates the correct orientation of the smartphone in order to capture the route.

The vehicle F can then execute the parking process autonomously, wherein the execution of the parking process can be initiated by means of an input by the user by means of the input device of the smartphone. The vehicle F can therefore park without a driver along a trajectory previously recorded by manual driving.

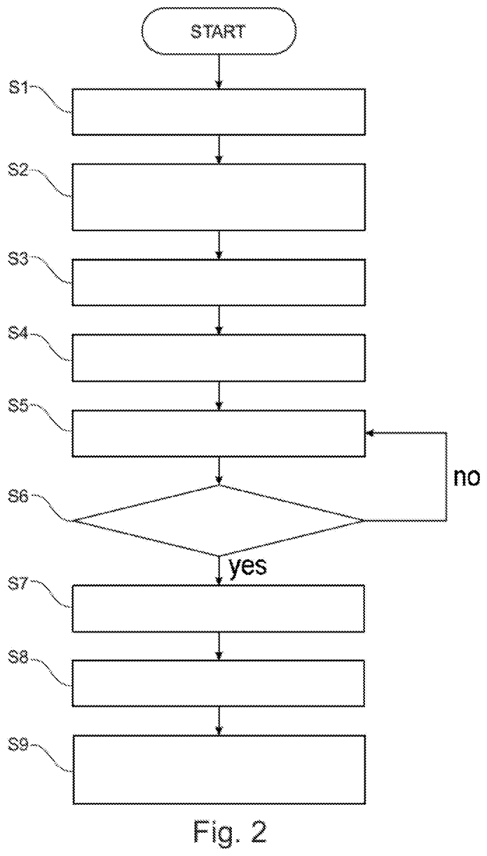

FIG. 2 shows a further flow diagram of an exemplary method having the steps S1 to S9.

After the start, in step S1 the vehicle F is positioned in a starting area of a parking assistance method. The parking assistance method permits autonomous parking of the vehicle F, wherein a specific route R is followed from a starting position in the starting area up to a target position Z. The route R to be implemented may have been travelled along once in advance manually and the associated trajectory produced and stored.

In step S2, the user gets out of the vehicle F and starts the computer program product or an application for executing the parking assistance method on his mobile terminal M, e.g. smartphone.

In step S3, the user activates the method for visualizing the route R to be followed, in response to which the camera device of the mobile terminal M is activated in step S4.

In step S5, the determination of the position of the mobile terminal M relative to the vehicle F is started. In step S6 it is checked whether it has been possible to determine this position. If this is not the case, the method goes back to step S5. Otherwise, the method proceeds to step S7.

The step S7 comprises steps I and II of FIG. 1, i.e. information about the position and orientation of the vehicle F with respect to its vehicle surroundings and with respect to the mobile terminal M as well as information about the route R to be followed is provided. This information can be retrieved e.g. from a memory unit of the mobile terminal M or transmitted to the mobile terminal M by means of a transmission device.

The step S8 comprises steps III to VI of the method which is described with reference to FIG. 1, so that reference is made to the statements there.

In step S9, the user can move around and film the surroundings of the vehicle; the photographic image A which is displayed on the display D is correspondingly updated. In this context, the profile of the route R to be followed and, if appropriate, further objects O, waypoints, target position Z, etc. are superimposed as virtual elements on the image A, so that augmented reality is generated.

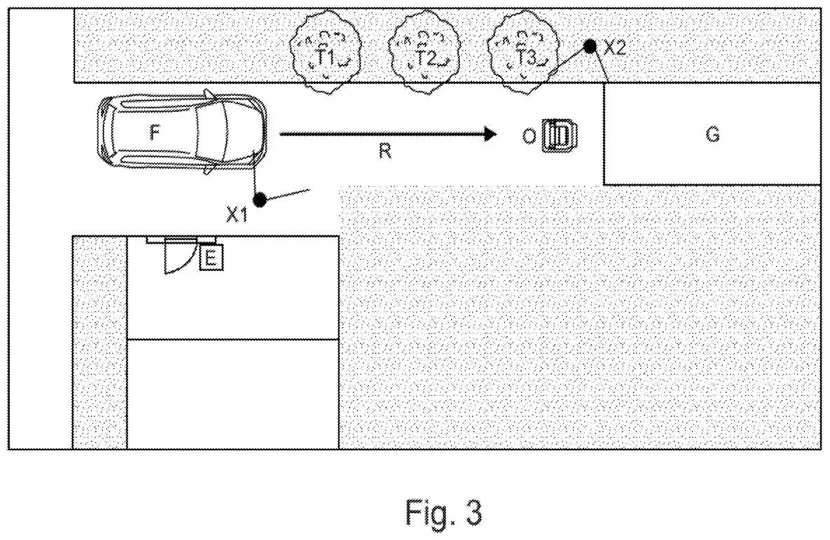

FIG. 3 shows an overview of an exemplary scenario in which the method for visualizing the route R to be followed can be used.

The vehicle F which is intended to execute a parking process autonomously by virtue of the fact that the route R is followed as far as the garage G is represented. In the surroundings of the vehicle there are, apart from the garage G, three trees T1, T2 and T3 as well as a house with a house entry E. The route R to be followed is blocked by an object O, in the exemplary embodiment a garbage container.

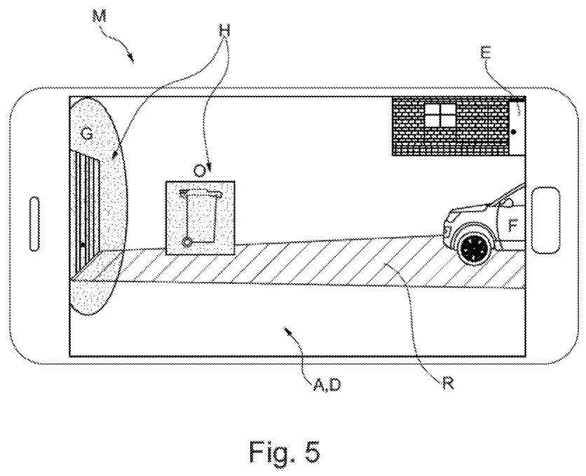

The user stops outside the vehicle F and considers the scenario. This may be done, for example, from the position X1 or X2, wherein the respective displayed image A is represented in FIGS. 4 and 5. Of course, the scenario can also be considered from other positions, for which a correspondingly adapted image A would be displayed.

FIG. 4 shows the image A, which is generated and displayed by means of the method for visualizing the route R, on the display D of the mobile terminal M when the user or the mobile terminal M is located at the exemplary position X1.

It is to be noted that the image A which is represented in FIG. 4 is preferably a photographic image which cannot be displayed in FIG. 4 owing to formal requirements of patent applications. This also applies to FIGS. 5 to 8.

The captured surroundings of the vehicle, i.e. the vehicle F, the garage G, the garbage container O and the trees T1, T2 and T3 are shown in the displayed image. Furthermore, the profile of the route R to be followed is represented in the form of a virtual element which is superimposed on the image A of the surroundings of the vehicle. Furthermore, for the sake of better orientation and as a warning indication the garbage container O and the garage G are highlighted by means of color marking.

FIG. 5 shows the corresponding image A from the position X2. Since the position X2 is located next to the trees T1, T2 and T3 (see FIG. 3) they cannot be seen in the image A, instead the house entry E lying opposite the trees T1, T2 and T3 can. If the user or the mobile terminal M moves from the position X1 to the position X2, the image A is correspondingly adapted on the basis of the respectively currently captured surroundings of the vehicle.

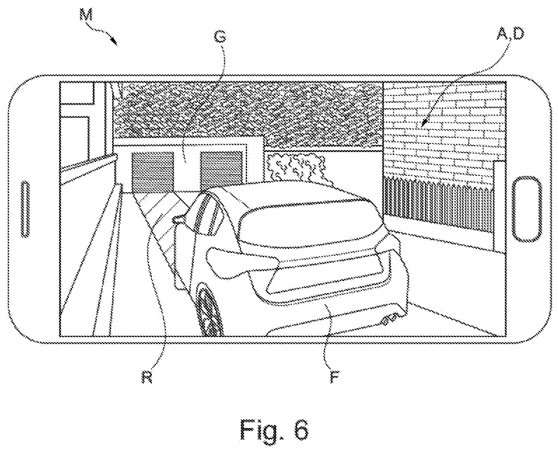

FIG. 6 shows a further exemplary image A of a vehicle F and its surroundings, wherein the profile of the route R to be followed is represented as a virtual element.

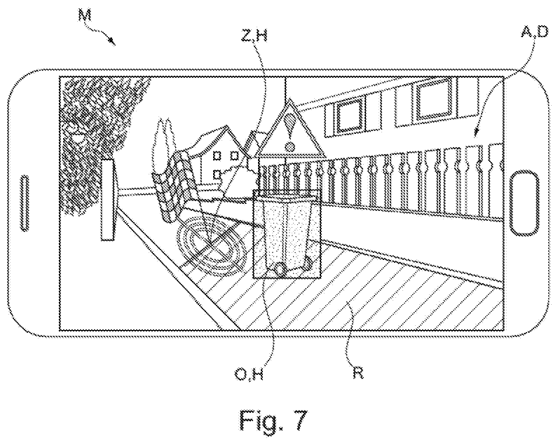

FIG. 7 shows a further exemplary image A of surroundings of the vehicle. The profile of the route R to be followed is represented as a virtual element. Furthermore, the garbage container O and the target position Z of the route R are highlighted.

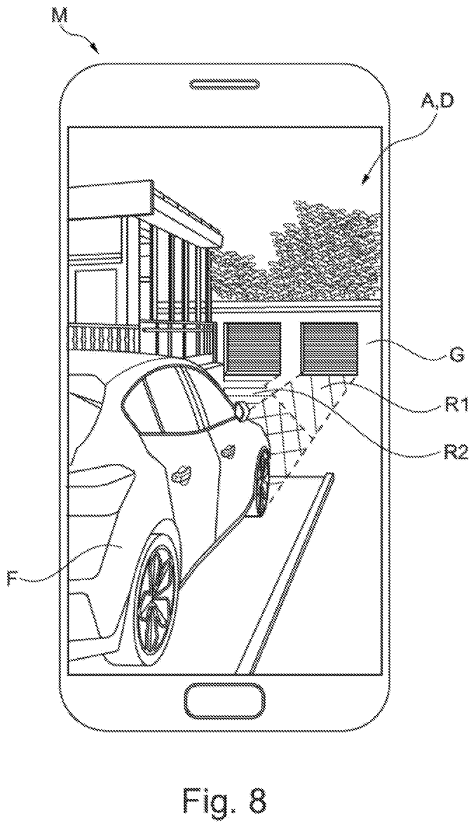

FIG. 8 shows a further exemplary image A of a vehicle F and its vehicle surroundings. The profiles of two alternative routes R1, R2 to be followed are represented as virtual elements. Differentiation of the two alternative routes R1, R2 is made possible, for example, by means of different coloring. The user can then select the desired route R1 or R2 by means of a touch command This selection can be transmitted to the vehicle F and used to carry out an autonomous parking process.

### LIST OF REFERENCE SYMBOLS

I Providing information about the position and orientation of the vehicle with respect to its vehicle surroundings and with respect to a mobile terminal
II Providing information about the profile of the route to be followed
III Capturing vehicle surroundings of the vehicle by means of a camera device of the mobile terminal
IV Determining the profile of the route to be followed in the captured vehicle surroundings on the basis of the information provided
V Displaying an image of the captured vehicle surroundings on a display of the mobile terminal
VI Representing the route to be followed in the image of the captured vehicle surroundings
S1 to S9 Method steps
A Image
D Display
E House entry
F Vehicle
G Garage
H Highlighted object
M Mobile terminal
O Object
R, R1, R2 Route
T1, T2, T3 Tree
X1, X2 Position of the user
Z Target position

1. A method for visualizing a route (R) to be followed by a vehicle (F), the method comprising:
providing information about a position and an orientation of the vehicle (F) with respect to surroundings of the vehicle and with respect to a mobile terminal (M) (I);
providing information about a profile of the route (R) to be followed (II);
capturing the surroundings of the vehicle (F) by a camera of the mobile terminal (M) (III);
determining the profile of the route (R) to be followed in the surroundings captured by the camera on the basis of the information provided (IV);
displaying an image (A) of the surroundings of the vehicle captured by the camera on a display (D) of the mobile terminal (M) (V); and
representing the profile of the route (R) to be followed in the image (A) of the surroundings (VI) of the vehicle captured by the camera.

2. The method according to claim 1, wherein the surroundings of the vehicle are captured dynamically and a dynamic image (A) is displayed.

3. The method according to claim 1, wherein the image (A) is a photographic image (A).

4. The method according to claim 1, further comprising:
highlighting objects (O) and/or waypoints in the image; and/or highlighting a target position (Z) of the route (R, R1, R2) to be followed in the image.

5. The method according to claim 1, further comprising:
representing alternative routes in the image (A) of the surroundings of the vehicle captured by the camera.

6. The method according to claim 5, comprising:
transmitting a selection of one of the alternative routes (R, R1, R2) to the vehicle (F).

7. The method according to claim 1, wherein the route (R, R1, R2) to be followed is a route of a parking process.

8. A system, comprising:
a processor; and
a memory having computer executable instructions that, when executed by the processor, cause the processor to:
receive information about a position and an orientation of a vehicle (F) with respect to surroundings of the vehicle and with respect to a mobile terminal (M) (I);
receive information about a profile of a route (R) to be followed (II);
capture images of the surroundings of the vehicle (F) by a camera of the mobile terminal (M) (III);
determine the profile of the route (R) to be followed in the surroundings captured by the camera on the basis of the information provided (IV);
display an image (A) of the surroundings of the vehicle captured by the camera on a display (D) of the mobile terminal (M) (V); and
represent the profile of the route (R) to be followed in the image (A) of the surroundings (VI) of the vehicle captured by the camera.

9. The system according to claim 8, wherein the surroundings of the vehicle are captured dynamically and a dynamic image (A) is displayed.

10. The system according to claim 8, wherein the image (A) is a photographic image (A).

11. The system according to claim 8, wherein the processor is configured to:
highlight objects (O) and/or waypoints in the image; and/or
highlight a target position (Z) of the route (R, R1, R2) to be followed in the image.

12. The system according to claim 8, wherein the processor is configured to:
represent alternative routes in the image (A) of the surroundings of the vehicle captured by the camera.

13. The system according to claim 12, wherein the processor is configured to, comprising:
transmitting a selection of one of the alternative routes (R, R1, R2) to the vehicle (F).

14. The system according to claim 8, wherein the processor is configured to, wherein the route (R, R1, R2) to be followed is a route of a parking process.
